(19) United States
(12) Patent Application Publication
(10) Pub. No.: US 2007/0214096 A1
(43) Pub. Date: Sep. 13, 2007

(54) Multi-Jurisdictional Electronic-Commerce Legal Products, Methods of Production and Methods of Conducting Business Therewith

(76) Inventors: Derek A. Newman, Seattle, WA (US); Brian R. Cartmell, Seattle, WA (US); Rod Collen, Seattle, WA (US)

Correspondence Address: NEWMAN & NEWMAN, ATTORNEYS AT LAW, LLP, 505 FIFTH AVENUE SOUTH, SUITE 610, SEATTLE, WA, 98104, US

(21) Appl. No.: 11/749,646

(22) Filed: May 16, 2007

Related U.S. Application Data
(63) Continuation of application No. 11/150,446, filed on Jun. 9, 2005.

(51) Int. Cl. G06Q 50/00

(52) U.S. Cl. 705/80; 705/1; 705/400

(57) ABSTRACT

The present invention provides novel e-commerce methods for the user-fabrication of jurisdiction specific documents of a legal nature and various methods of conducting business comprising such methods, fabricated documents and a system encompassing such methods and products.

The present application is a continuation or divisional of and claims the benefit of the filing date of application Ser. No. 11/150446 and contains no new matter in relation thereto.

### FIELD OF THE INVENTION

The present invention relates to E-commerce methods and products and the system therefor, and more particularly to documents and materials prepared and designed for use in specific jurisdictions as desired, and which are offered and disseminated by way of E-commerce, and further to an array of methods of conducting business employing such E-commerce methods and products.

### BACKGROUND OF THE INVENTION

The ever increasing popularity of the Internet continues to provide an expanded array of opportunities for individuals to purchase electronic commerce (“e-commerce”) items over a global network with access from any of a number of terminals, such as a personal computer or laptop, or a mobile telephone or other wireless phone devices enabled with Short Message Service (“SMS”), Multimedia Messaging (“MMS”) or Enhanced Messaging Service (“EMS”) protocol, or a Personal Digital Assistant (“PDA”) and the like which may access the mobile Internet by way of a WAP (“Wireless Applications Protocol”) site. Such devices are commonly used to purchase from online merchants electronic commerce methods and products which do not need to be physically delivered to a purchaser user, and which in some instances may be simply download from an Internet web site. Some examples include electronic ticket confirmation, software products and other executables. In other instances, there may be provided electronic-commerce products in the form of an electronic receipt or indication of purchase of a physical object, such as a product purchased over the Internet for later delivery or from e-commerce auctions.

In one example, International Patent Applications No. PCT/EP01/06435 discusses the purchase of e-commerce objects associated with an interactive address link pointing to specific web sites or an additional e-commerce object. The specific web site or additional e-commerce web site provides information relating to the e-commerce object. After receipt of the e-commerce object by purchaser, the web site may then be accessed by interfacing with an address link within the e-commerce object to obtain information stored on the web site.

An interactive e-commerce product is also discussed in U.S Patent Application Publication No. 20020140735 in which a website performs in the manner of a paper publication such that it may be read like a book or a magazine in which each screen display represents a double page spread which a user may turn like book pages. The interactive system may also use different features in the manner of a combination of text, sound, motion, images or video in a multimedia format.

Another example includes U.S. Patent Application publication No. 20030212582 which discloses a network-based method and system which automates the process of evaluating a consumer's legal claim, and based on an analysis of the merits of the claim automates electronic acceptance of the consumer's legal claim or automates electronic rejection of the claim, as based on E-SIGN Electronic Signatures in Global and National Commerce Act which allows for such a business model. In use, this system and method collects claim information from consumers who have potential product liability claims and automatically scores and automatically evaluates and scores those claims according to factual and medical indicators established for such a product claim, and once scored the system decides to either reject the consumer for legal representation or attempt to retain the consumer. Law firms may use this system to send electronic mail notifying a consumer of a decision not to offer representation or a decision to offer representation with an electronic contract generated and forwarded for the consumer to digitally sign online to retain the services of the firm.

In U.S. Patent Application Publication No. 20030084004 there is disclosed the automated assembly of an electronic contract by way of contracts generated by a word processor or those scanned into a system and then modified by way of a contract encoder which uses an encoding system to encode contract parameters according descriptions published by a modeller. The contract encoder links descriptors for a formal contract to structural textual contract descriptors by way of provided associations, and with the formal contract model defining allowable values that can be assigned to each descriptor. During the encoding of a specific contract descriptors are assigned appropriate values defined by a contract drafting tool. This system is somewhat disadvantageous as a user must still search the Internet or other sources for the most appropriate contract format, such as by way of a search engine before contract drafting. The automated contract drafter is also not designed to comport to local laws, rules or regulations.

Still other examples include an interactive Internet-based insurance marketing method and system for the purchase of insurance products as disclosed in U.S. Patent Application Publication No. 20020046063; an Internet-based method and system for the purchase of products from Internet vendors as disclosed in U.S. Patent Application Publication No. 20010027427; Internet-based contract labor agreements with authorized electronic payment for services rendered as disclosed in U.S. Patent Application Publication No. 20020161619; an Internet-based method for entering and/or cancelling service contracts such as disclosed in European Patent Application No. 1187047; and an Internet-based method and system for investing corporate working capital as disclosed in U.S Patent Application Publication No. 20050119958.

As may be ascertained, there exist yet many opportunities for innovative methods and systems to fully exploit the Internet venue in offering and vending services and products, and especially those of an interactive nature where products with attendant services may be purchased and/or actually constructed and then stored by way of a web site for later retrieval and use. To this end there has not been provided an automated way of composing contracts, agreements, wills and other legal documents by way of e-commerce, such as by a user in virtually any geographic location being provided a menu as a starting point for document construction, and in which such documents of a legal nature may be tailored to be jurisdictional specific or for use in specified factual contexts.

### SUMMARY OF THE INVENTION

In accordance with that above, the present invention fulfills a longfelt need by providing an Internet-based e-commerce method and system for choosing templates and self-constructing contracts, agreements and other documents of a legal nature online which are jurisdictional specific and optionally periodically updated for changes in the applicable law, and which may further be stored in a central depositary for safe keeping and retrieval on demand, and for reformatting and amending as based upon changing facts, laws, statues, rules, regulations and other intrinsic and extrinsic factors.

The invention is more fully explained and understood with reference to the following Detailed Discussion of Preferred Embodiments with accompanying drawings.

### BRIEF DESCRIPTION OF THE DRAWINGS

FIG. 1, drawing sheets 1 through 13, illustrate a document prepared by a user in accordance with the invention which is automatically fabricated as jurisdiction specific as desired.

FIG. 2, drawing sheet 14, illustrates “Example 1” an example of a questionnaire.

FIG. 3, drawing sheets 15 and 16, illustrate “Example 2,” an example of an annotation alert.

### DETAILED DISCUSSION OF PREFERRED EMBODIMENTS

All patent references, published patent applications and literature references referred to or cited herein are expressly incorporated by reference to the same extent as if each were specifically and individually incorporated by reference. Any inconsistency between these publications and the present disclosure is intended to and shall be resolved in favor of the present disclosure.

In the following discussion many specific details are provided to set forth a thorough understanding of the present invention. It will be obvious, however, to those skilled in the art that the present invention may be practiced without specific details, and in some instances of this discussion, with reference to the drawing, known elements have not been illustrated in order not to obscure the present invention in unnecessary detail. Such details concerning computer networking, software programming, telecommunications and the like have not been specifically illustrated as such are not considered necessary to obtain a complete understanding of the core present invention, but are considered present nevertheless as such are considered to be within the skills of persons of ordinary skill in the art.

Additionally, the processing depicted in the drawings and described below is generally depicted as hierarchical in structure for readability and understandability. Various other methodologies, such as object oriented techniques, are contemplated for the physical embodiments of the invention such as to maximize the use of existing programming technique. One of ordinary skill in the art will appreciate that the techniques described herein may be embodied in many different forms.

Furthermore, for illustrative purposes only, the following discussion illustrates and discusses the present invention in reference to various embodiments which may, perhaps, be best utilized subject to the desires and subjective preferences of various users. One of ordinary skill in the art will, however appreciate that the present invention may be utilized to produce by way of e-commerce any sort of agreement, contract, memorandum of understanding, letter of intent, will and the like or any document of a legal nature or with legal ramifications, any of which may be tailored to specific language and recitations representative of the legalities of specific jurisdictions as desired.

Having thus prefaced this discussion, the present invention provides an e-commerce method, product and system for users to efficiently and effectively construct and/or prepare any type of document of a legal nature or with legal ramifications, such as contracts, agreements, wills and the like employing preformatted skeletal drafts of such documents tailored to encompass language tailored to the legalities, and preferably local custom and usage, of specific jurisdictions, such as to requirements of terms and the like in accordance with state law, rules and regulations as applicable. As known, for example, in the case of contracts and various agreements such usually need to be prepared with respect to an established context, oftentimes employing an existing contract history with attendant background information. Their preparation may also oftentimes become an involved laborious affair, complicated in nature, and usually only competently handled by a legal professional at not insubstantial cost. The present invention, by way of Internet and e-commerce capability, eliminates or least substantially reduces such complexities in contract and agreement preparation, and that of other legal documents, by interactively enabling a user to select a starting construct or template document from a provided menu and through an electronic interview means to use same to fabricate a finished document of a legal nature reflecting or dictated by the parties' intent, such as contractual intent, and as dictated by surrounding facts and circumstances. The thus fabricated document is preferably automatically tailored to reflect language, where appropriate in the body of the document, through the interactive interview means which is jurisdiction-specific to state law, local laws, rules and regulations, or even to that of any jurisdiction or geographic location foreign to the United States and its territories. By the term “parties” as used herein it is meant to refer to any person or persons, whether direct contracting parties or ancillary parties, such as third party beneficiaries, or any business entity which may be involved in any way with the subject matter of a document. A document may be one that requires the execution of only one party, such as an assignment or power of attorney, or may involve several parties. However, the term “parties” will oftentimes be defined with precision within a specific document.

In one preferred exemplified embodiment, there is provided an interactive e-commerce system usable on an Internet accessible means, or by way of a wireless device, such as an SMS, EMS or MMS enabled phone, through, for instance, a WAP site, for the automated drafting of a contract or agreement, or other document of a legal nature. The system comprises an electronic Internet accessible image repository for storing an electronic file of an image of a template or construct of a desired document type, such as, for instance, a contract in the nature of a cohabitation agreement, or some type of living or partnering agreement or other document of a legal nature. The type of agreement, or document for that matter, is not critical to the practice of this invention which contemplates the e-commerce assisted self-fabrication of virtually any jurisdiction-specific document. For ease of understanding a document which is contractual in nature is employed in this illustration.

Further, the system includes an interactive question and user response means of which a user is confronted with and prompted to respond to determine and display an appropriate incomplete construct or template reflecting jurisdiction specific language as appropriate, and optionally, a modeller means for storing descriptions for a formal contract model, or for storing a preformatted or partially constructed model (a “construct” or “template”), and a tool means for enabling the contract or agreement to be formatted and displayed as desired, or optionally according to the preformatted model. The modeller means may make layout models for documents, such as a contract or agreement, available through the repository and a tool which enables a document to be formatted according to the layout model displayed, all of which are made available to users of the e-commerce repository.

In other preferred embodiments, there are contemplated Internet web site accessible constructs or templates of documents available for purchase which may be modified as to contemplated parameters, terms and the like in accordance with the results of an interactive question and response means. In accordance with a user-completed interactive question and response means, a document formatter means may be employed to display a jurisdiction specific layout model and tools to create a structured textual document, such a contract, on the basis of the contract image. E-commerce contract drafting techniques and examples of suitable methodologies are discussed, for example, in U.S. Patent Application Publication No. 20030084004.

Many agreements found useful by people during recent times are those which reflect conditions, facts and circumstances outside of a traditional marital status. To this end, some contemplated examples of constructs or templates of documents which may be selected or otherwise made available to a user in accordance with this invention include, without limitation, a partnering agreement; a co-habitation or living together agreement; a living will health care directive which set out how one may want to be cared for if terminally ill or incapacitated in some way, or if permanently unconscious and unable to communicate will instruct one's desires how far one's life should be prolonged; parenting agreements which may set out the parties' intentions of parenting a child together; a power of attorney; wills and codicils, a living trust to retain control of one's property while alive; joint debt agreements; agreements reflecting financial decisions; agreements with terms as to joint purchases; joint property ownership agreements; appointment of a successor trustee; appointment of a successor executor and personal representative; appointment of a successor health care agent; and a revocation of a power of attorney. These examples are in no way intended to be limiting of this invention and merely illustrate some of the many different types of jurisdiction specific documents which may be fabricated in accordance with the invention, and also illustrate the invention's advantageous flexibility. Indeed, as another illustration a contract for the sale of goods tailored to comport to a state's specific form of Uniform Commercial Code provisions is also contemplated for use herein.

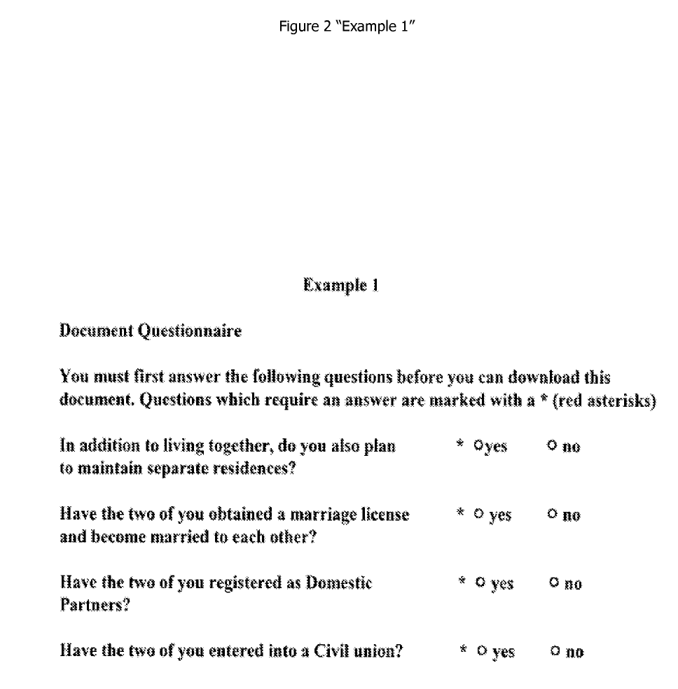

Further in accordance with other preferred embodiments of this invention, once a document construct is selected from an Internet web site provided menu, or perhaps an MMS message, preferably a version specific to a user-indicated jurisdiction such as a state or based, for example, on a zip code or an address, a user may be prompted to answer one or more of a series of questions pertaining to the specific document. For example, in the case of a living together agreement, a questionnaire may be presented as depicted in “Example 1” found in FIG. 2, sheet 14.

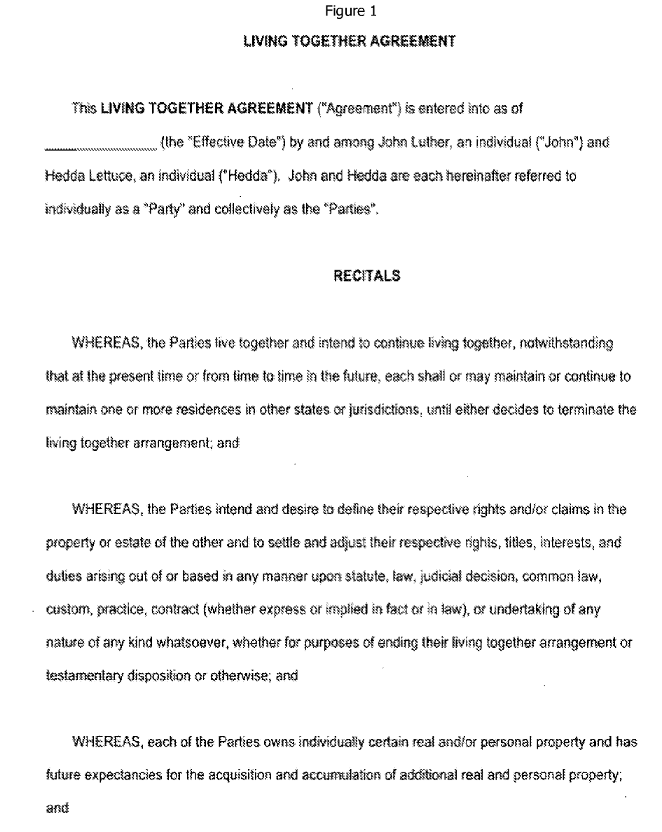

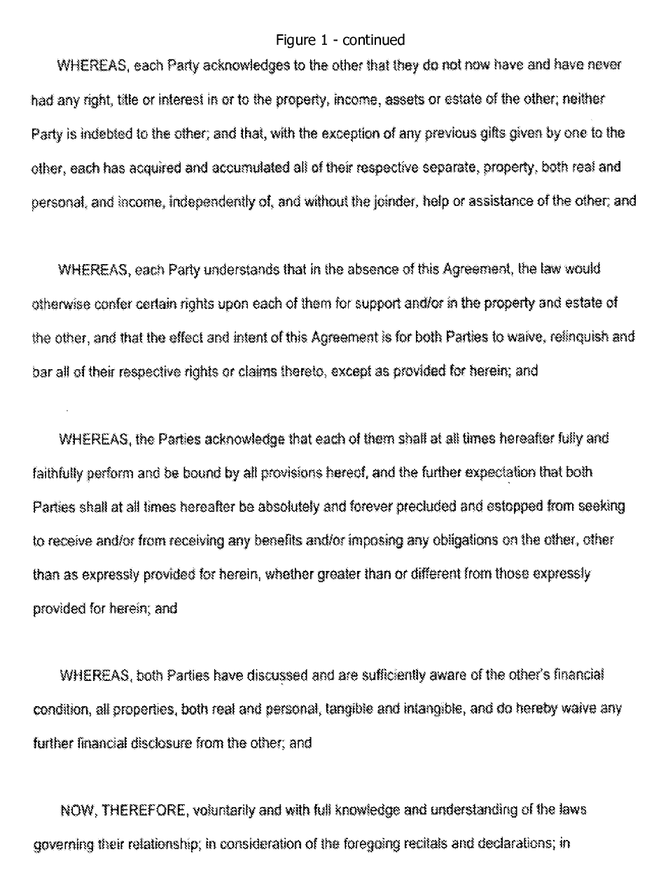

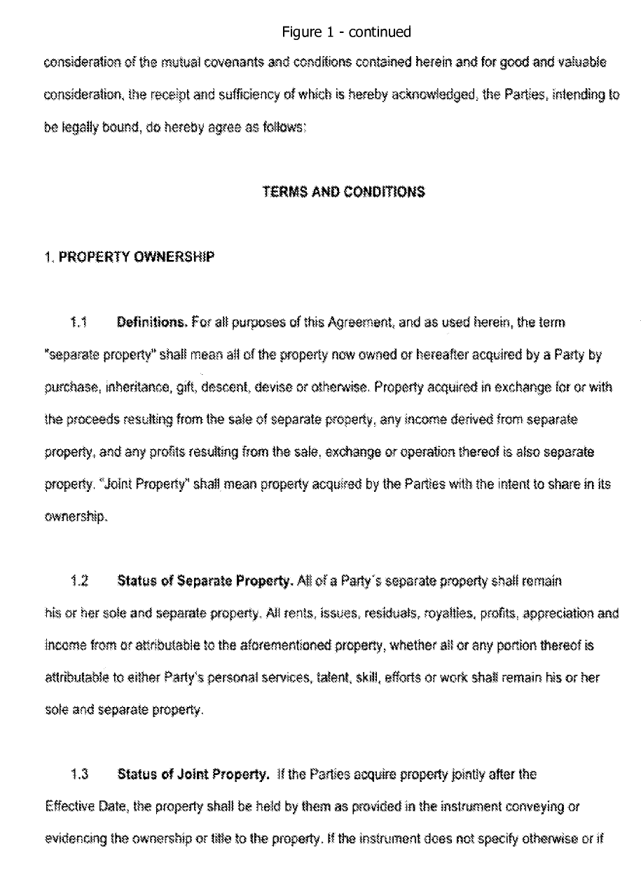

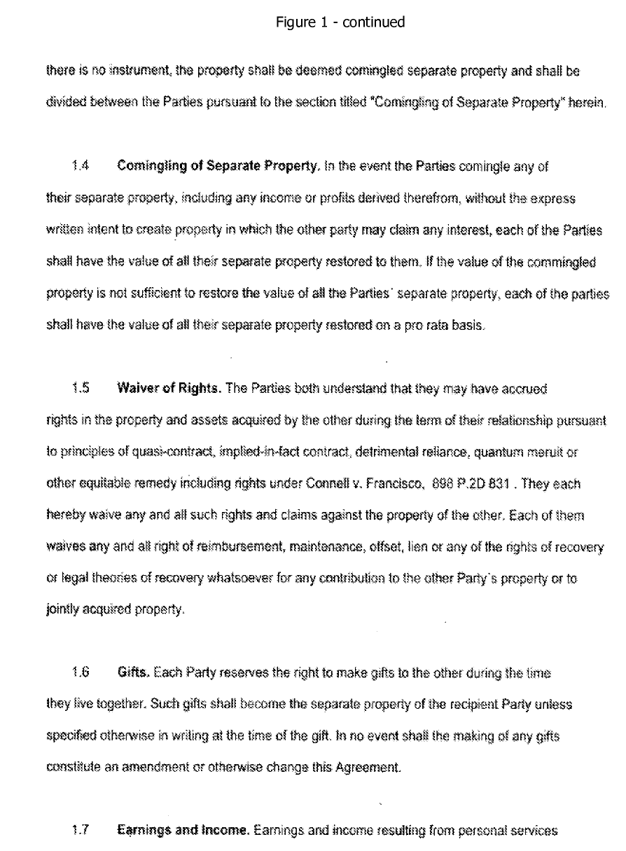

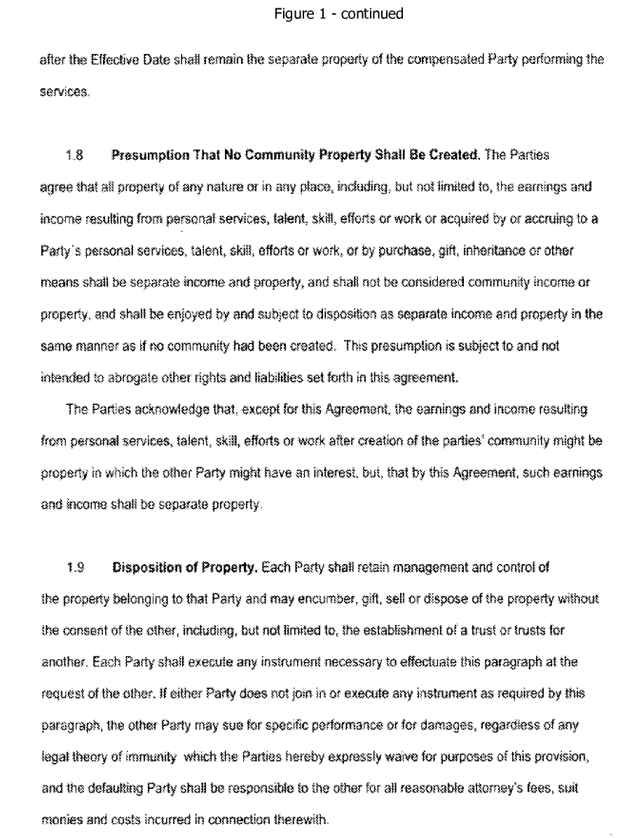

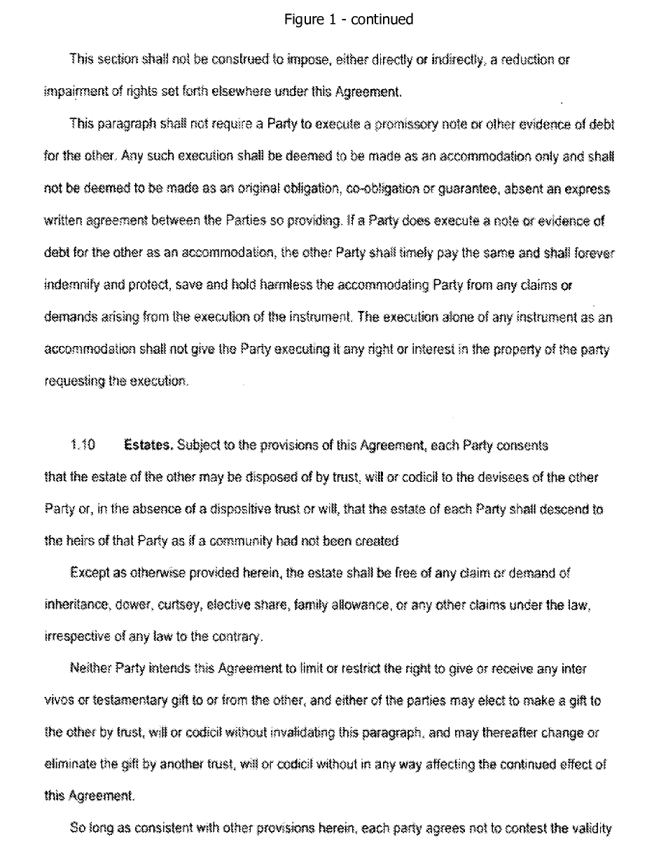

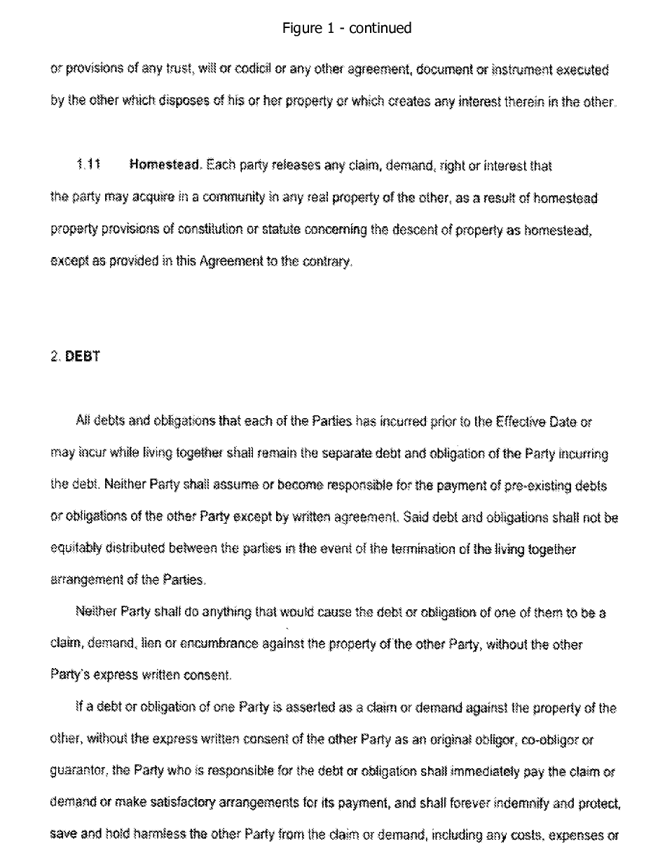

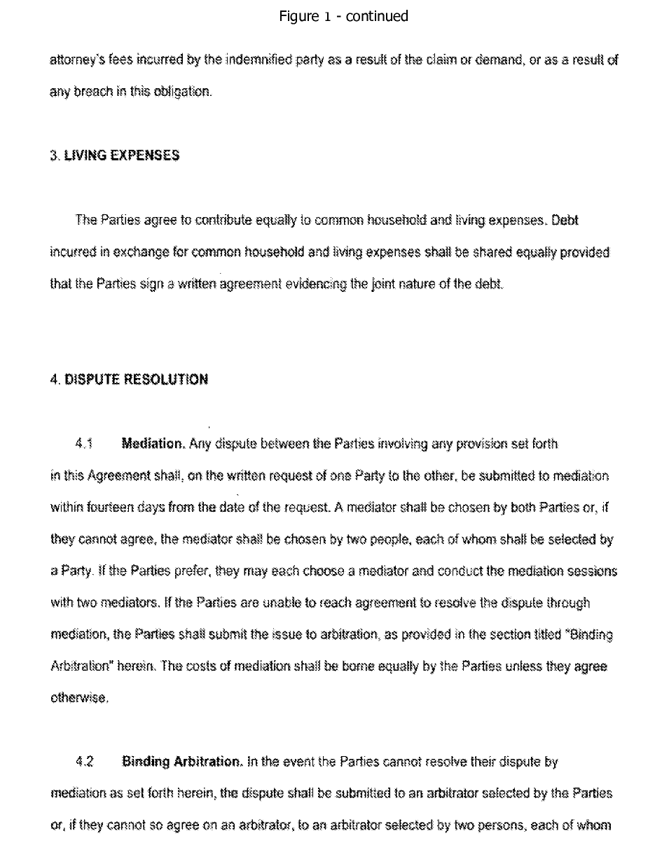

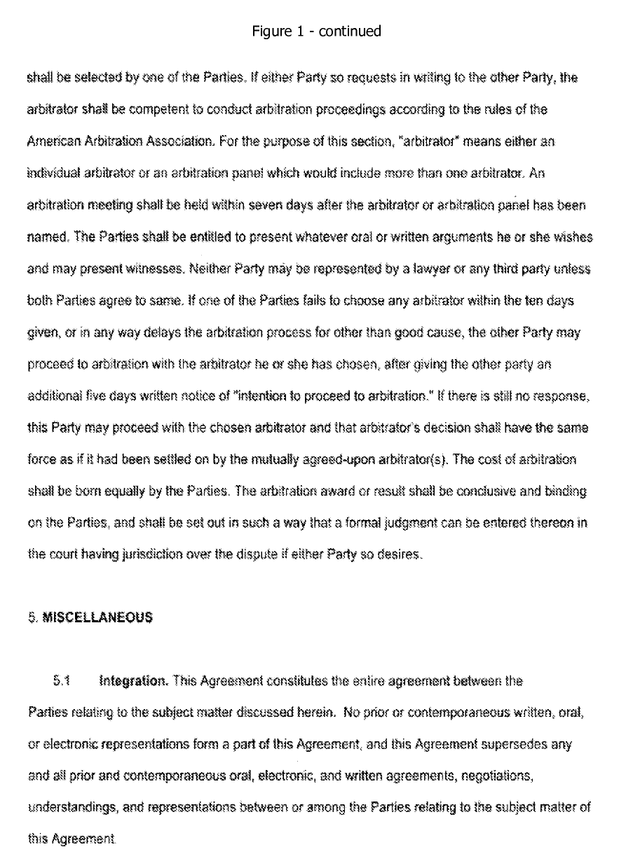

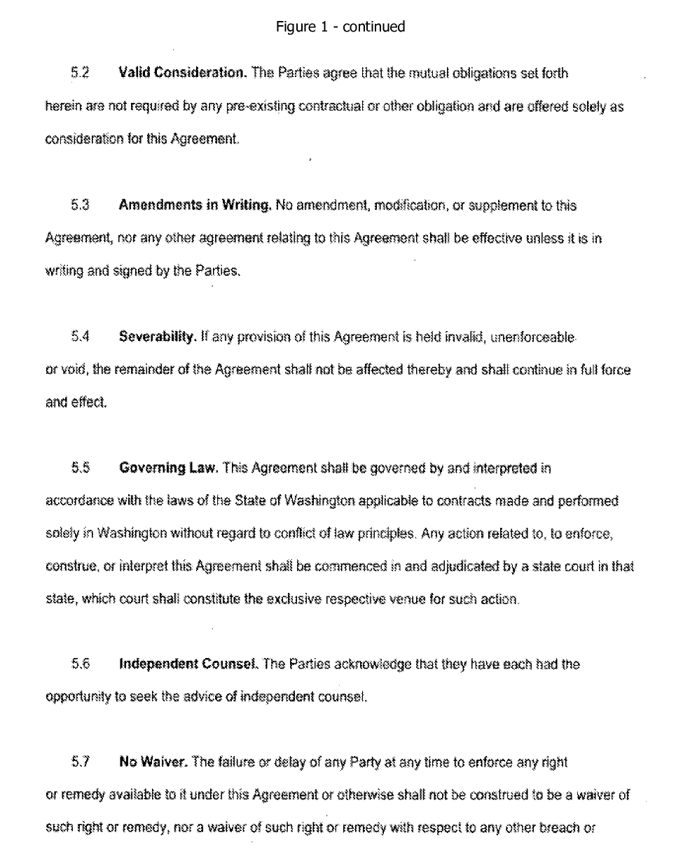

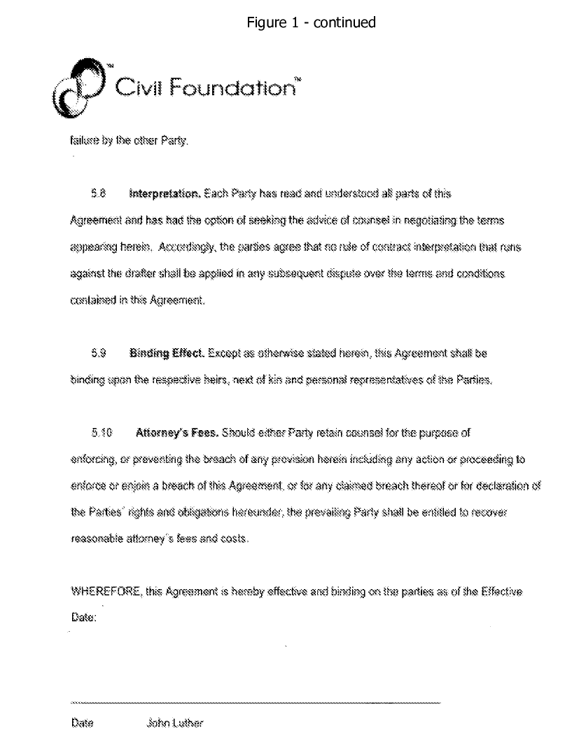

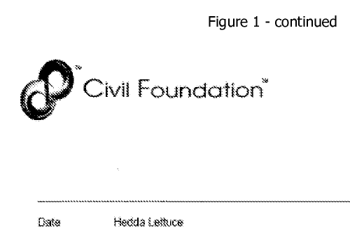

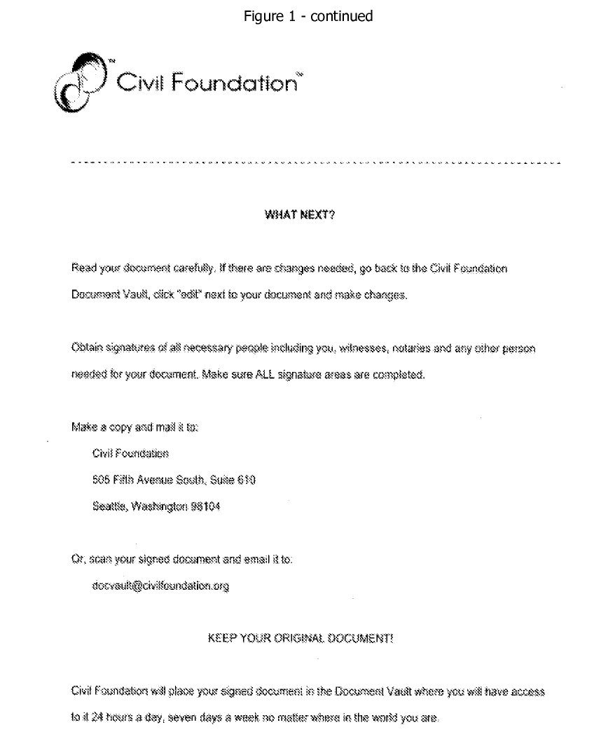

Upon completion of the questionnaire, a document reflecting appropriate language in response to the user's answers may then be downloaded for the automatic fabrication of a custom made document with parameters tailored to the facts and circumstances, and intent, of the user(s), and which is also jurisdiction specific. An example of a user-created, jurisdiction specific document is shown in FIG. 1.

The present invention also optionally provides an annotation feature accessible by a user contemplating a particular document which displays a summary of the local law applicable to the nature of the document and the facts and circumstances of the user, and which is updated as required to reflect changes in the law. This feature, which may be made available, for example, in a drop down menu when a user is contemplating a document specific to a certain jurisdiction, is particularly useful as a consultation database by those contemplating a relocation to other jurisdictions, or perhaps for those doing business in various jurisdictions or have entered into some form of a contract or agreement in one or more jurisdictions.

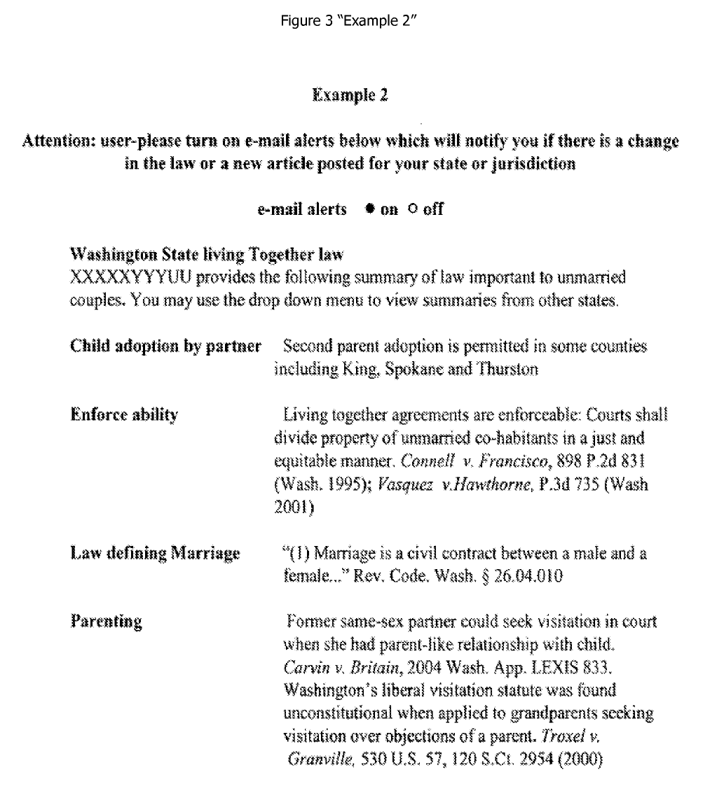

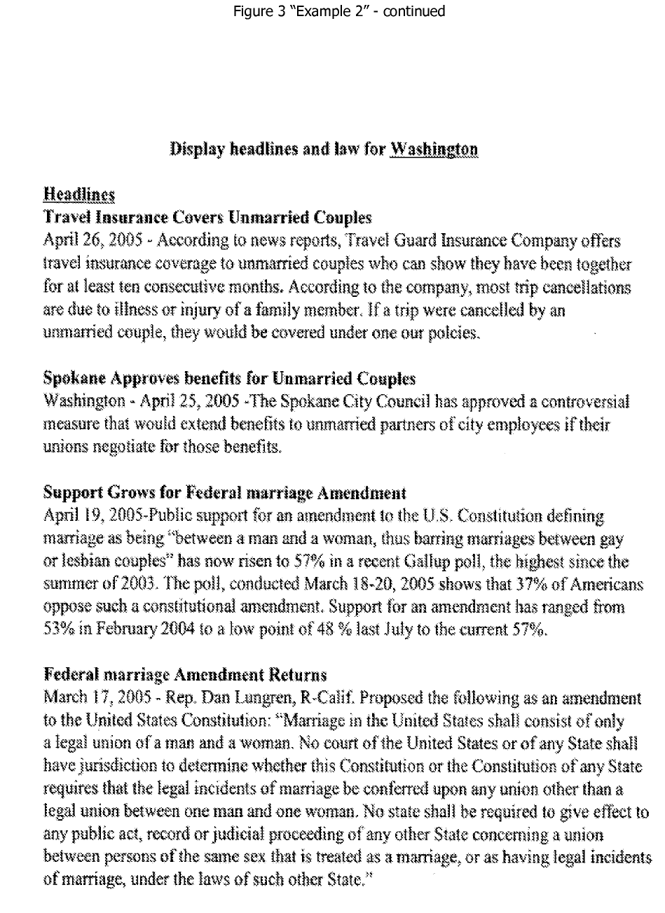

User alerts are also contemplated by the invention to alert a user, such as by e-mail, to recent changes in a legal environment in a specific jurisdiction. An example of such an annotation alert is illustrated in “Example 2” found in FIG. 3, drawing sheets 15 and 16.

As will be appreciated, a user do-it-yourself database is thus provided by the invention with annotated services searchable as to legal implications in a state or other specific jurisdiction with respect to a particular document reflecting certain circumstances and facts 24 hours a day any day of the week, and searchable by anyone located in any geographic area with access to an Internet web site or e-mail.

In another preferred embodiment of the invention, a user-created, jurisdiction specific document may be automatically stored in a database for safe keeping and for easy locating and retrieval as desired or when the need arises. For example, when an alert informs a user as to a change in local law, rules or regulations, the user may sign in to the inventive service with, perhaps, a password or electronic signature, to make necessary changes to any of the user's existing and stored documents to reflect such changes as appropriate. This feature is particularly convenient while a person may be in transit or in a location where access to and consultation with traditional files is not possible. The database may be maintained on any server, remote or otherwise, and may store a plurality of user-created, jurisdiction specific documents, or several of the same type of document, but with each specific to the legalities in different jurisdictions for the creation of a personal document library complete with jurisdiction specific annotations, as described above, and headline archives. As one may imagine, such features also provide particular advantages in the educational arena, such as in a business or business law course of studies or in a law school or comparative law environment. It will also provide significant advantages to those whose lifestyle or employment duties routinely traverse several jurisdictions, such airline workers or other workers traveling internationally and encountering frequent legal environment changes.

In yet another aspect and embodiment of the present invention, it is further contemplated that the multi-jurisdictional e-commerce created document products of the invention, their method of production and a system encompassing such products and methods may be employed in conjunction with conducting one or more, or an array of business methods and functions, such as designing, manufacturing, marketing, selling, licensing, and leasing endeavors, or employed as subject matter for the production of valuable trade mark and tradedress rights, or perhaps as novel subject matter to be used in the formation of a business entity, such as a partnership, joint venture or corporation and the like. Other contemplated embodiments of this aspect of the invention include the partnering of business entities or of other persons and with offered discounts for member users of a partner entity for promotional purposes or advantages, such as, for instance, established bar associations, automobile associations and other trade groups and the like. Still other contemplated embodiments include an Internet web site accessible online message board or chat service encompassing the invention, for example, to promote or encourage discussion of relevant issues and perhaps changing laws, and also to provide a convenient venue for members to meet each other

It will be further appreciated by those persons skilled in the art that the embodiments described herein are merely exemplary of the principles of the invention. Such are merely intended to be illustrations and are not intended to be limiting of the scope or spirit of the invention or claims in any way, and many modifications and variations are possible without departing from the spirit and scope of the invention and claims.

1. A method of creating a document comprising:
providing at least one starting document template, which at least one document template comprises
a plurality of descriptions of legal rights and/or responsibilities which may exist between parties in at least one jurisdiction, and
fields which may be completed by user input;
soliciting input from the at least one user regarding
the legal rights and responsibilities which such at least one user intends to be recorded in the document,
the jurisdiction which controls the at least one user and/or another party, and
the content to comprise the fields which may be completed by user input;
selecting at least one of the descriptions of rights and/or responsibilities which correspond to the user input;
creating the document by
compiling the selected descriptions and the user input, if any, regarding the content to comprise the fields which may be completed by user input,
adding content which may be made part of the document template regardless of user input,
adding an identifying code, and
formatting such assembled components as the document;
making the created document accessible; and
transmitting alerts to the at least one user when there has been a change in law relevant to a created document, an annotation, and/or a at least one starting document template.

2. The method of claim 1 where soliciting input is through an electronic interview comprised of questions with multiple choice responses which responses correspond to various of the plurality of descriptions of legal rights and/or responsibilities which may exist between parties in a plurality of jurisdictions.

3. The method of claim 1 where soliciting input from the at least one user comprises soliciting input via a computer browser technology and/or an SMS, EMS, or MMS enabled phone.

4. The method of claim 1 further comprising providing annotations in association with the document and/or the at least one starting document template which annotations comprise at least one summary of law pertinent thereto.

5. The method of claim 4 where the annotations are provided in a searchable database.

6. The method of claim 1, where transmitting alerts further comprises transmitting alerts via email, via computer browser technology, and/or via an SMS, EMS, or MMS enabled phone.

7. The method of claim 1, where transmitting alerts further comprises transmitting an alert which includes a reference to a previously created document.

8. The method of claim 1 where transmitting alerts further comprises inviting the user to access a system embodying the method of claim 1 through which the user may make a change to a previously created document.

9. The method of claim 1 further comprising charging the at least one user a fee.

10. The method of claim 1 where making the created document accessible comprises making the created document accessible as an electronic file which may be accessed via a browser and/or an SMS, EMS, or MMS enabled phone.

11. The method of claim 1 further comprising providing a forum where the at least one user may interact with others, which others may include other at least one users, if any.

12. The method of claim 1 where creating the document and adding thereto an identifying code further comprises a code which is a bar code.

13. A computer system comprising:
at least one data structure in which to store
at least one document template, which at least one document template comprises a plurality of descriptions of legal rights and/or responsibilities which may exist between parties in a plurality of jurisdictions, and fields which may be completed by user input;
at least one created document;
computer instructions that, when implemented,
solicit input from at least one user regarding
the legal rights and responsibilities which such at least one user intends to be recorded in the document,
the jurisdiction which controls the at least one user and/or another party, and the content to comprise the fields which may be completed by user input;
select at least one of the descriptions of rights and/or responsibilities which correspond to the user input;
create a document by
compiling selected descriptions and the user input, if any, provided with respect to the fields which may be completed by user input,
adding thereto such content which may be part of the document template regardless of user input,
adding thereto an identifying code, and
formatting such assembled components as the document;
make a created document accessible;
provide annotations in association with a created document and/or in association with the at least one starting document template, which annotations comprise a summary of law pertinent thereto;
transmit alerts to at least one user when there has been a change in law relevant to a created document, an annotation, and/or a at least one starting document template;
at least one computer processor suitable to execute instructions;
at least one communication system which provides communication between a user and the at least one computer processor;
at least one communication system which provides communication between the at least one data structure and the at least one computer processor.

14. The computer system according to claim 13 further comprising computer instructions that, when implemented, charge at least one user a fee.

15. The computer system according to claim 13 further comprising computer instructions that, when implemented, transmit alerts via email, via computer browser technology, and/or via an SMS, EMS, or MMS enabled phone.

16. The computer system according to claim 15 where the computer instructions that, when implemented, transmit alerts via email, via computer browser technology, and/or via an SMS, EMS, or MMS further comprise instructions that, when implemented, transmit an alert which includes a reference to a previously created document.

17. The computer system according to claim 15 where the computer instructions that, when implemented, transmit alerts via email, via computer browser technology, and/or via an SMS, EMS, or MMS further comprise instructions that, when implemented, transmit an alert which invites a user to access the system and invites a user to consider making a change to a previously created document.

18. The computer system according to claim 13 further comprising computer instructions that, when implemented, solicit input from at least one user via email, via computer browser technology, and/or via an SMS, EMS, or MMS enabled phone.

19. The computer system according to claim 13 further comprising computer instructions that, when implemented, make a created document accessible as an electronic file which may be accessed via a browser and/or an SMS, EMS, or MMS enabled phone.

20. The computer system according to claim 13 further comprising computer instructions that, when implemented, provide a forum where at least users of the system can interact.

21. The computer system according to claim 13 where such identifying code is a bar code.
